(19) United States
(12) Patent Application Publication
(10) Pub. No.: US 2025/0234914 A1
(43) Pub. Date: Jul. 24, 2025

(54) FRUIT PRESS FOR FRUITS WITH A PEEL

(71) Applicant: Citrocasa GmbH, Linz (AT)

(72) Inventor: Johannes Huber, Luftenberg (AT)

(21) Appl. No.: 18/970,919

(22) Filed: Dec. 6, 2024

(30) Foreign Application Priority Data
Jan. 22, 2024 (AT) A50035/2024

(51) Int. Cl. A23N 1/00; A47J 19/02

(52) U.S. Cl. CPC A23N 1/003; A47J 19/02

(57) ABSTRACT

A fruit press for fruits with a peel has press tools that can be attached to shafts of a frame and can be driven in opposite directions. The press tools comprise two press rollers arranged on either side of a blade and two ram heads underneath the press rollers that comprise press rams that engage in press recesses of the press rollers, with axial stops that are associated with a common carrier and lie under an elastic pretension against stop surfaces of the attached press tools, and with at least one tie rod held in the frame and passing through a blade holder and the carrier for the axial support of the carrier. A tensioning lever is mounted on the carrier on the side facing away from the blade holder and engages with a bearing axle in a carrier-side sliding guide running transversely to the tie rod and with a tensioning axle in a bearing recess of the tie rod. The bearing recess is provided on the side of the sliding guide facing away from the carrier and is open towards the carrier, wherein the distance of the bearing recess from the sliding guide is smaller than the distance of the bearing axle from the tensioning axle.

The invention relates to a fruit press for fruits with a peel, with press tools which can be attached to shafts of a frame which can be driven in opposite directions and wherein the press tools comprise, on the one hand, two press rollers arranged on either side of a blade and, on the other hand, two ram heads provided underneath the press rollers and which comprise press rams engaging in press recesses of the press rollers, with axial stops which are associated with a common carrier and which lie under an elastic pretension against stop surfaces of the attached press tools, and with at least one tie rod held in the frame and passing through a blade holder and the carrier for axially supporting the carrier.

For pressing fruits with a peel, in particular oranges, it is known (AT 508944 A1, EP 2412252 B1, EP 2314174 B1) to convey the fruits with a peel into the intermeshing area between two press rollers, where they are picked up in press recesses and halved with the help of a blade lifted up from below between the press rollers, before the fruit halves are pressed out in the press recesses by press rams, which are arranged on ram heads mounted below the press rollers and driven synchronously with the press rollers. These press tools are detachably mounted on parallel, conical multi-edge shafts and are each secured on their associated shafts, which are mounted in a common frame, by axial stops formed by a common carrier. To fasten the carrier, a tie rod held in the frame in a tension-proof manner is provided, which passes through the blade holder and the carrier with a threaded section, so that the carrier can be displaced along the tie rod with the aid of a fastening nut and thus the stops, which are designed as rubber-elastic pressure bodies, can be adjusted to the press tools under an elastic pretension. As a result of these measures, it is only necessary to remove the carrier to remove the press tools from their shafts for cleaning purposes. A disadvantage, however, is that the application of a corresponding elastic pretension to the rubber-elastic pressure bodies depends on the tightening torque of the fastening screw and thus on the care with which the press tools are reattached to their shafts after cleaning and axially secured with the help of the common carrier.

It is also known (WO 2020/198773 A1, U.S. Pat. Nos. 11,766,063 B2, 11,089,807 B2) to use the front holder as a stop for axial support attachments of the press rollers and ram heads in order to axially secure the press tools held between a front holder and a rear wall of a handling unit on their conical shafts, so that when the handling unit is attached to a frame having the conical shafts, the press tools pushed onto the conical shafts with the handling unit are axially secured by the handling unit, but without elastic pretensioning. This also applies to another known embodiment (CN 211459748 U), in which the press tools are axially secured on their conical shafts by a common, multi-armed carrier, which can be screwed tightly to a frame having the conical shafts by means of a threaded bolt and axially secures the press tools by ball bearings provided in the arms and engaging in corresponding receptacles of the press tools.

The invention is thus based on the problem of creating an easy-to-handle pull-off safety device which ensures a predetermined elastic pretension with which the stops of the common carrier can be pressed against the stop surfaces of the press tools.

Based on a fruit press of the type described at the beginning, the invention solves the problem in that a tensioning lever is provided, which is mounted on the carrier on the side facing away from the blade holder and which engages with a bearing axle on the carrier side in a sliding guide running transversely to the tie rod and with a tensioning axle in a bearing recess of the tie rod, which bearing recess is provided on the side of the sliding guide facing away from the carrier and is open towards the carrier, wherein the distance of which bearing recess from the sliding guide is smaller than the distance of the bearing axle from the tensioning axle.

When the tensioning lever is actuated, its tensioning axle is first inserted into the bearing recess in the tie rod, which is open towards the carrier, before the tensioning lever is rotated around the tensioning axle engaging in the bearing recess due to the design specifications and at the same time the bearing axle is displaced along the sliding guide with the effect that the distance between the sliding guide and the bearing recess in the tie rod increases. This displacement of the carrier relative to the tie rod, which displacement is dependent on the rotary movement of the tensioning lever between an initial position and a tensioning position, can be advantageously used to apply a predetermined elastic pretension to the axial stops. The spring travel required for a specific pretension can thus be determined by the design-related path of the carrier relative to the tie rod when the tensioning lever is pivoted.

To apply an elastic pretension to the carrier, the tie rod could be supported against the frame by a compression spring, the pretension of which is applied to the carrier when the tensioning lever is tensioned. However, the design conditions are simpler if the carrier supported on the stop surfaces of the press tools can be subjected to a bending stress by the tensioning lever for elastic pretensioning of the stops, because in this case the carrier itself can be used as a pretensionable spring. In addition, the tie rod for tensioning the tensioning lever can be supported in the frame in a tension-proof manner.

Particularly favorable spring properties can be achieved with a carrier in the form of a carrier plate forming the stops. For the corresponding deflection of the carrier plate, the stop surfaces of the press tools pushed onto the shafts must protrude axially in relation to the end face of the blade holder at least in accordance with the spring travel specified by the tensioning lever.

In order to create simple assembly conditions, the slotted-hole-like sliding guide can have an open insertion end for the bearing axle of the tensioning lever on the side of the bearing recess of the tie rod, so that the tensioning lever can be inserted into the sliding guide with the bearing axle in an assembly position, in which the connecting line between the bearing axle and the tensioning axle preferably runs transversely to the tie rod and thus at least approximately in the direction of the sliding guide, before the tensioning lever is, in order to insert the tensioning axle into the bearing recess of the tie rod, rotated about the bearing axle, which is preferably located at the end of the sliding guide. If the tensioning lever with the tensioning axle engaging in the bearing recess of the tie rod is rotated further about this tensioning axle as the axis of rotation, the distance between the sliding guide on the carrier side and the tie rod for pretensioning the stops for the press tools is increased accordingly.

A guide wall can be provided for the safe insertion of the tensioning axle of the tensioning lever into the bearing recess of the tie rod, which guide wall adjoins the open insertion end of the sliding guide and delimits an insertion path for the tensioning axle upstream of the bearing recess of the tie rod.

To ensure that the tensioning lever is secured independently in the tensioning position, it can also be provided that the bearing axle engages in the sliding guide with lateral guide play, that the tensioning lever forms two stop surfaces interacting with the carrier on the one hand for an initial position and on the other hand for a tensioning position, as well as a cam track between the two stop surfaces in relation to the bearing axle, and that the cam track has a cam lift in regards to the guide play of the bearing axle. The cam track increases the tensioning travel of the tensioning lever with the effect that the stop surface for the tensioning position of the tensioning lever is pressed against the carrier under a corresponding pretension, thereby holding the tensioning lever in its tensioning position. In order to be able to use the cam lift of the cam track, the bearing axle held in the sliding guide must allow this cam lift, which requires a lateral guide play of the bearing axle in the sliding guide corresponding to this cam lift. The initial position of the tensioning lever preferably corresponds to its assembly position, which is thus determined by the stop surface associated with the initial position.

In order to be able to use a sensor to check whether the tensioning lever for axially securing the press tools attached to the shafts has been actuated, the tie rod can be axially pulled out of a stop-limited initial position into a stop-limited working position against the force of a return spring when the tensioning lever is actuated, whereby in the stop-limited initial position the tensioning axle engages in the bearing recess of the tie rod without displacing the tie rod. The travel of the tie rod between its initial position and the working position can be used for the response of the sensor without this travel influencing the tensioning of the tensioning lever. Provided that the forces of the return spring are smaller than the pretensioning forces for the stops for axially securing the press tools attached to the shafts, the tie rod is initially only axially displaced into the working position, in which it is supported against the frame in a tension-proof manner, before the pretension for the stops can be applied.

The tensioning lever, which is preferably loose in relation to the carrier, facilitates cleaning but makes handling more difficult. To improve handling, the tensioning lever can have a releasable latch that interacts with a pivot stop on the carrier side that delimits the initial position of the tensioning lever. In the locking position of the latch, the tensioning lever is prevented from being pivoted beyond the pivot stop into a release position that allows the tensioning lever to be released from the sliding guide. In the locking position of the latch, the carrier thus forms a handling unit with the tensioning lever.

If two tie rods are provided on both sides of the blade, symmetrical load conditions can be ensured without having to accept a more complex design with regard to the function of the tensioning lever, because the tensioning lever can have a tensioning axle in common for interaction with the bearing recesses of the two tie rods.

The drawing shows an example of the object of the invention. It shows

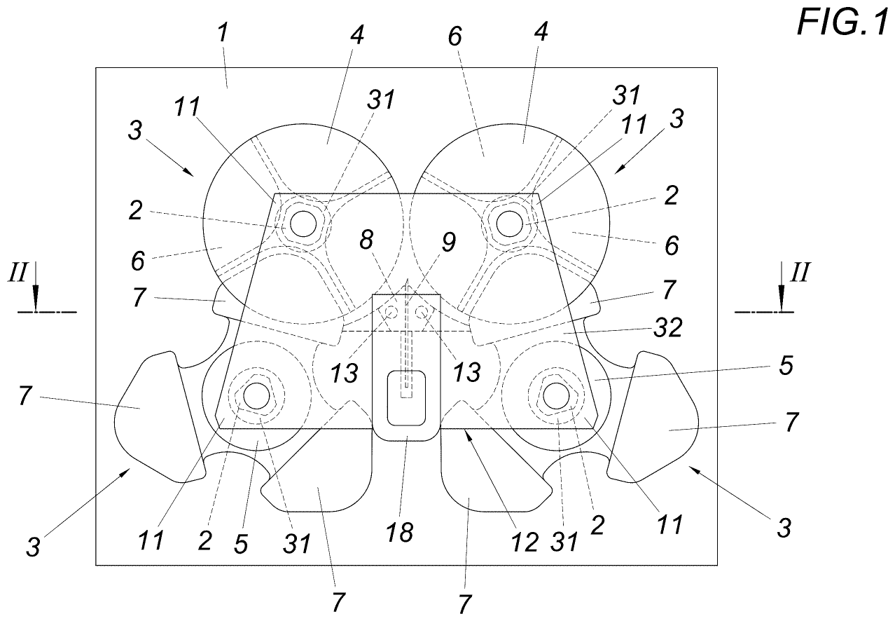

FIG. 1 a sectional view of a fruit press according to the invention, showing the front of the press tools,

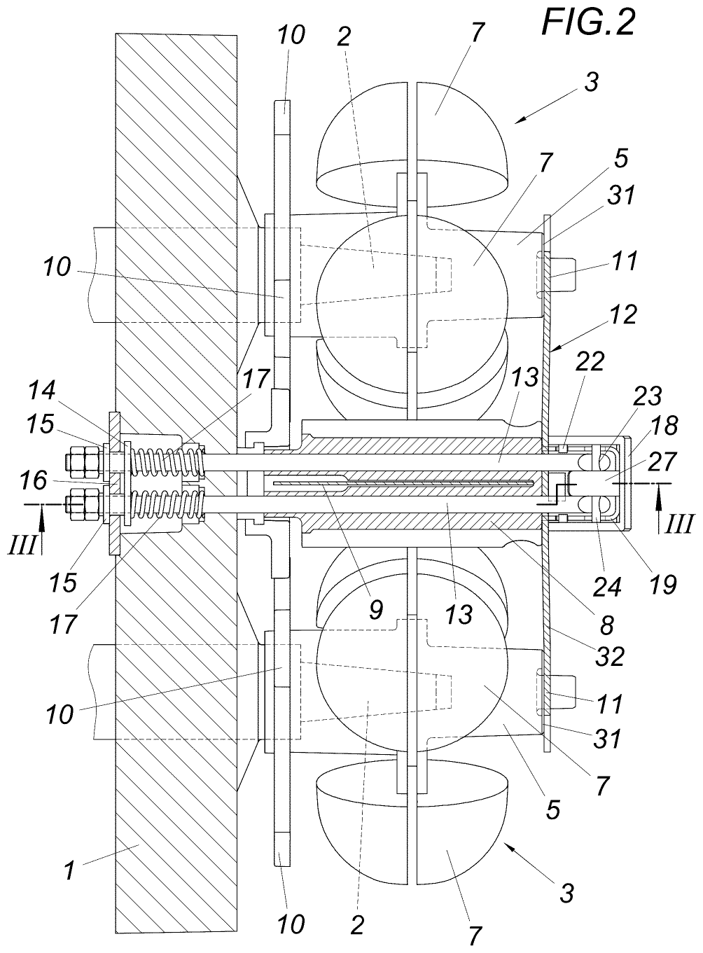

FIG. 2 a section according to line II-II of FIG. 1 on a larger scale,

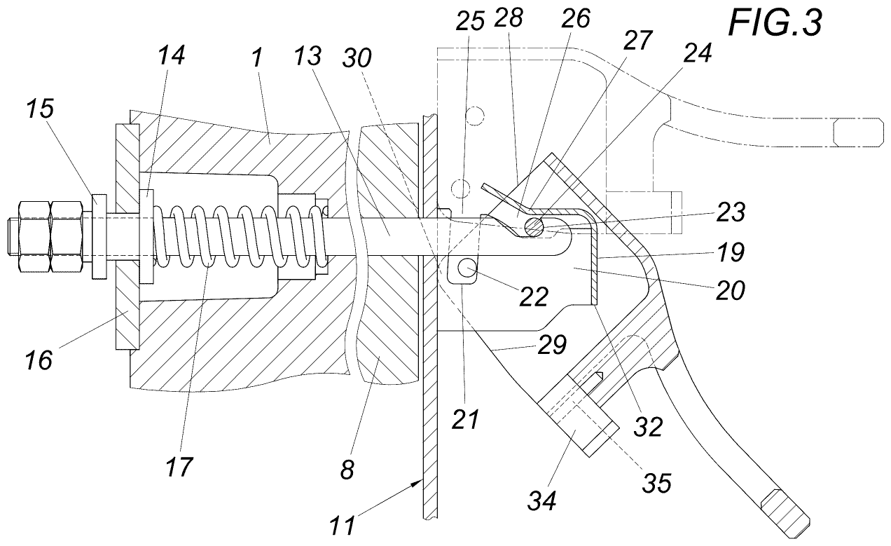

FIGS. 3 to 5 different positions of the tensioning lever in a section corresponding to line III-III of FIG. 2 on a larger scale and

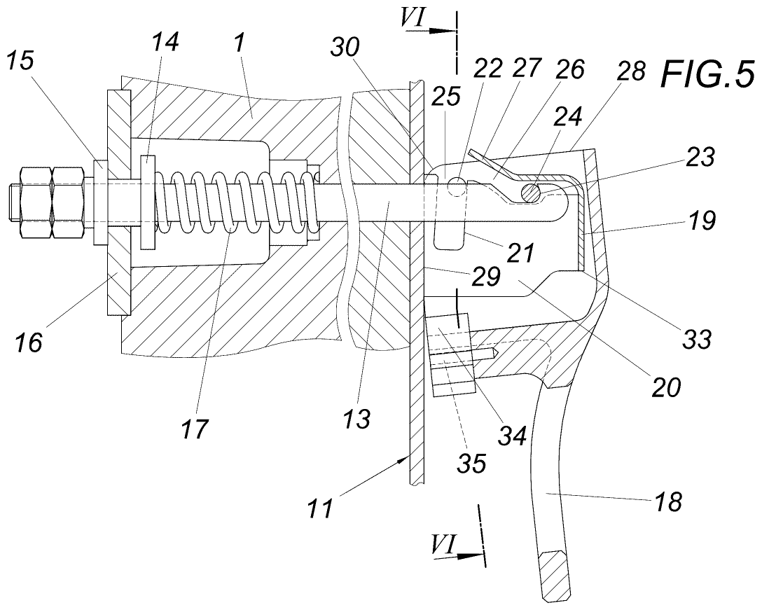

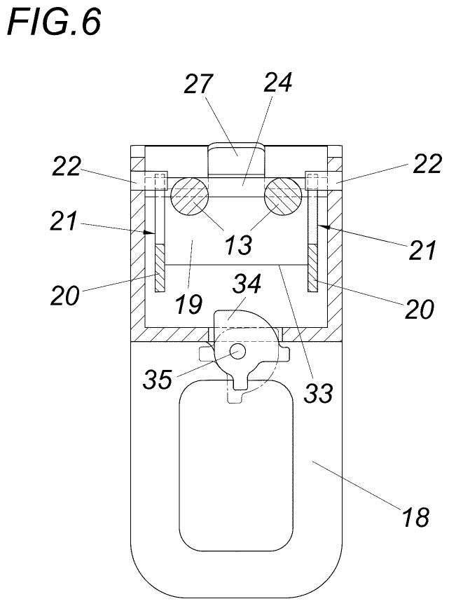

FIG. 6 a section along line VI-VI of FIG. 5 on a larger scale.

A fruit press according to the invention conventionally has a frame 1 with projecting shafts 2 for press tools 3, namely two press rollers 4 and two ram heads 5 cooperating with the press rollers 4. The press rollers 4 are provided with press recesses 6 which cooperate with press rams 7 of the ram heads 5. In the intermeshing area between the press rollers 4, a blade 9 is provided which is displaceably mounted in a blade holder 8 and which is acted upon for the cutting stroke by means of driving cams 10 assigned to the ram heads 5. The fruits with a peel to be pressed out are conveyed from above into the intermeshing area between the press rollers 4 via a feed channel not shown and picked up by the press recesses 6 in order to be conveyed downwards against the raised blade 9. Since the press rams 7 of the ram heads 5 penetrate the press recesses 6 as the press rollers 4 continue to rotate, the fruit halves picked up by the press recesses 6 are pressed out by the press rams 7. The remaining peel halves with the fruit residues adhere to the press rams 7 and are discharged from the press recesses 6 of the press rollers 4 by the press rams 7 and then stripped off by the press rams 7 and fed to a collecting container.

In order to secure the press tools 3 pushed onto the conical shafts 2, which are designed as multi-edge shafts, against axial withdrawal, axial stops 11 are provided for the press tools 3, which are assigned to a common carrier 12 and are preferably formed by this carrier 12. To connect the carrier 12 to the frame 1, at least one tie rod 13 is provided, which passes through the blade holder 8 and the carrier 12. According to the embodiment example, two tie rods 13 are arranged on both sides of the blade 9. These tie rods 13 are mounted in the frame 1 so as to be axially displaceable with limited stops and for this purpose are provided with two stops 14, 15 on both sides of a stop plate 16. With the aid of return springs 17, the tie rods 13 are held in an initial position determined by the stop 14, from which they can be displaced against the force of the return springs 17 into a working position predetermined by the stop 15, in which they are supported against the frame 1 in a tension-resistant manner.

A tensioning lever 18 engages the tie rods 13 and is guided in a U-shaped bearing bracket 19 provided on the carrier 12. For this purpose, the lateral cheeks 20 of the bearing bracket 19 form sliding guides 21 extending transversely to the tie rods 13 for a bearing axle 22, formed by two stub axles, of the tensioning lever 18 engaging around the bearing bracket 19. On the side of the sliding guide 21 facing away from the carrier 12, the ends of the tie rods 13 projecting into the bearing bracket 19 are provided with a bearing recess 23 open towards the carrier 12 for a tensioning axle 24 of the tensioning bracket 18, the distance of which from its bearing axle 22 is greater than the distance of the tensioning axle 24 from the sliding guide 21.

On the side of the bearing recesses 23 of the tie rods 13, the sliding guide 21 has an open insertion end 25 for the bearing axle 22 of the tensioning lever 18, which is adjoined by a guide wall 27 arranged in front of the bearing recesses 23 of the tie rods 13 and delimiting an insertion path 26 for the tensioning axle 24. The bearing axle 22 of the tensioning lever 18 engages in the sliding guide 21 with lateral play, which corresponds at least to the sliding movement of the tie rods 13 between their initial position and their working position, which is determined by the stops 14 and 15.

The tensioning lever 18, which is loose relative to the bearing bracket 19, has two stop surfaces 28 and 29 interacting with the carrier 12, on the one hand for an assembly position and on the other hand for a tensioning position, as well as a cam track 30 between the two stop surfaces 28, 29, which is related to the bearing axle 22, wherein the cam track 30 is formed with a cam lift within the guide play of the bearing axle 22.

For mounting, the tensioning lever 18 released from the bearing bracket 19 is placed with its stop surface 28 against the carrier 12 for the mounting position in a position engaging around the bearing bracket 19, whereby the bearing axle 22 of the tensioning lever 18 is located above the open insertion end 25 of the sliding guide 21, as shown in dotted lines in FIG. 3. The tensioning lever 18 can now be displaced along the carrier 12 until the bearing axle 22 is in contact with the closed end of the sliding guide 21 and can be rotated about the bearing axle 22 in order to allow the tensioning axle 24 to slide along the insertion path 26 into the bearing recesses 23 of the tie rods 13 projecting over the carrier 12 after the carrier 12 has been slid on. In the tensioning lever position shown with full lines in FIG. 3, the engagement position of the tensioning axle 24 in the bearing recesses 23 of the tie rods 13 is reached before the tie rods 13 are displaced.

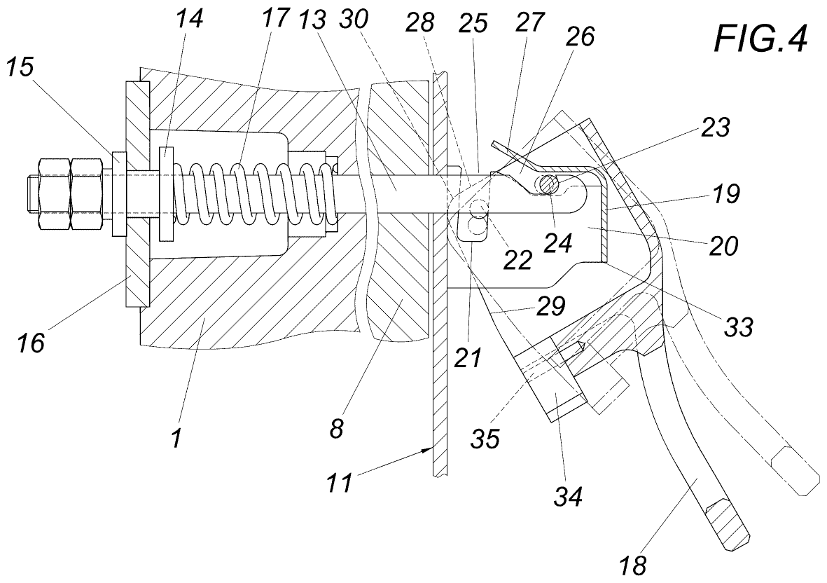

When the tensioning lever 18 is turned further from this position indicated by a dotted line in FIG. 4 around the tensioning axle 24 held in the bearing recesses 23, the tensioning lever 18 is supported by the cam track 30 on the carrier 12 with the effect that the tie rods 13 are pulled from the initial position according to FIG. 3 against the force of the return springs 17 into the working position according to FIG. 4, which is shown with full lines in FIG. 4. This travel of the tie rods 13, which travel results in an empty stroke in relation to the application of a corresponding elastic pretension for the stops 11, is used to respond to a conventional sensor, which indicates the proper actuation of the tensioning lever 18.

To fully tension the tensioning lever 18, it must be turned further to the stop of the stop surface 29 on the carrier 12 as shown in FIG. 5, whereby the distance between the tensioning axle 24 and the sliding guide increases and therefore the carrier 12 is displaced in the direction of the blade holder 8 due to the support of the tie rods 13 in the housing 1, which support is tension-proof in the working position. With a correspondingly elastic carrier 12, the stops 11 formed by the carrier 12 or provided on the carrier 12 are thus subjected to an elastic pretension in order to be held pressed against the stop surfaces 31 of the press tools 3 with this elastic pretension. In order to be able to provide advantageous spring properties for the carrier 12, the carrier 12 can be designed as a carrier plate 32 forming the stops 11.

To release the carrier 12, the tensioning lever 18 is to be turned in the opposite

direction from the tensioning position as shown in FIG. 5 until the tensioning axle 24 emerges from the bearing recesses 23 of the tie rods 13 and the carrier 12 can be pulled off. In order to prevent the tensioning lever 18 from becoming detached from the bearing bracket 19 and thus simplify handling, the tensioning lever 18 can have a releasable latch 34 that interacts with a pivot stop 33 on the carrier side that limits an initial position of the tensioning lever 18. A structurally simple design is obtained if the latch 34 is designed as a rotary latch, which is mounted so as to be rotationally adjustable about an axis 35 extending transversely to the stop surface 29 between a locking position shown with solid lines in FIG. 6 and a release position indicated by a dotted line.

As FIGS. 3 and 4 show the assembly and the initiation of the tensioning movement, FIGS. 3 and 4 show the latch 34 in the release position. After tensioning the tensioning lever 18, the latch 34 can be pivoted into the locking position as shown in FIG. 5.

1. A fruit press for fruits with a peel, said fruit press comprising:
press tools attached to shafts of a frame, said shafts being driven to rotate in opposite directions to each other;
wherein the press tools comprise;
two press rollers arranged on either side of a blade, said press rollers having press recesses therein, and
two ram heads supported underneath the press rollers, wherein said press rams comprise press rams that engage in the press recesses of the press rollers;
axial stops that are associated with a common carrier and lie under an elastic pretension against stop surfaces of the press tools, which are attached thereto; and
at least one tie rod held in the frame and passing through a blade holder and the carrier so as to provide axial support of the carrier;
wherein a tensioning lever is mounted on the carrier on a side thereof facing away from the blade holder, and said tensioning lever engages with a bearing axle in a carrier-side sliding guide running transversely to the tie rod; and
the tie rod having a bearing recess therein; and
a tensioning axle in the bearing recess of the tie rod, said bearing recess being provided on a side of the sliding guide away from the carrier and said bearing access being open towards the carrier;
wherein the bearing recess is at a distance from the sliding guide that is smaller than a distance of the bearing axle from the tensioning axle.

2. The fruit press according to claim 1, wherein the carrier supported on the stop surfaces of the press tools is subjected to a bending stress by the tensioning lever and provides said elastic pretension of the stops.

3. The fruit press according to claim 2, wherein the carrier is a carrier plate and wherein the stop surfaces of the press tools pushed onto the shafts project axially with respect to an end surface of the blade holder.

4. The fruit press according to claim 1, wherein the sliding guide is slotted and has, on a side of the bearing recess of the tie rod, an open insertion end receiving the bearing axle of the tensioning lever.

5. The fruit press according to claim 4, wherein a guide wall is arranged upstream of the bearing recess of the tie rod and delimits an insertion path for the tensioning axle, and adjoins the open insertion end of the sliding guide.

6. The fruit press according to claim 1, wherein the bearing axle engages with lateral guiding play in the sliding guide,
wherein the tensioning lever forms two stop surfaces interacting with the carrier so as to provide a starting position and a tensioning position, and a cam track between the two stop surfaces that is associated with the bearing axle, and
wherein the cam track has a cam lift operative with the guide play of the bearing axle.

7. The fruit press according to claim 1, wherein the tie rod, when the tensioning lever is actuated, is configured to be pulled axially out of a stop-limited initial position into a stop-limited working position against force of a return spring, wherein, in the stop-limited initial position, the tensioning axle engages in the bearing recess of the tie rod.

8. The fruit press according to claim 1, wherein the tensioning lever has a releasable latch that interacts with a pivot stop on the side of the carrier that delimits a starting position of the tensioning lever.

9. The fruit press according to claim 1, wherein the tie rod is one of two tie rods that are each provided on a respective side of the blade.

10. The fruit press according to claim 2, wherein the sliding guide is slotted and has, on a side of the bearing recess of the tie rod, an open insertion end receiving the bearing axle of the tensioning lever.

11. The fruit press according to claim 3, wherein the sliding guide is slotted and has, on a side of the bearing recess of the tie rod, an open insertion end receiving the bearing axle of the tensioning lever.

12. The fruit-press according to claim 10, wherein a guide wall is arranged upstream of the bearing recess of the tie rod and delimits an insertion path for the tensioning axle, and adjoins the open insertion end of the sliding guide.

13. The fruit-press according to claim 11, wherein a guide wall is arranged upstream of the bearing recess of the tie rod and delimits an insertion path for the tensioning axle, and adjoins the open insertion end of the sliding guide.
